(19) United States
(12) Patent Application Publication
(10) Pub. No.: US 2017/0277930 A1
(43) Pub. Date: Sep. 28, 2017

(54) CONTROL METHOD AND DEVICE FOR TERMINAL

(71) Applicants: Le Holdings (Beijing) Co., Ltd., Beijing (CN); Lemobile Information Technology (Beijing) Co., Ltd., Beijing (CN)

(72) Inventor: Haosen Suo, Beijing (CN)

(21) Appl. No.: 15/335,174

(22) Filed: Oct. 26, 2016

Related U.S. Application Data
(63) Continuation of application No. PCT/CN2016/096424, filed on Aug. 23, 2016.

(30) Foreign Application Priority Data
Mar. 25, 2016 (CN) 2016101801345

(51) Int. Cl. G06K 9/00; G06F 21/32; G06F 3/041

(52) U.S. Cl. CPC G06K 9/0002; G06F 3/0416; G06F 3/0414; G06K 9/00087; G06F 21/32

(57) ABSTRACT

Embodiments of the present disclosure provide a control method and device for a terminal. The control method for the terminal provided by the embodiments of the present disclosure comprises: acquiring operation information of a user at an edge touch area of the terminal in a screen locking state; and controlling the terminal to execute unlocking operation according to the operation information of the user at the edge touch area of the terminal. With the technical solutions of the present disclosure, when the terminal is controlled to unlock, the operation is simple and convenient, the unlocking efficiency of the terminal is improved. The problem that the unlocking efficiency of the terminal is relatively low due to inconvenient operation when the terminal with a large touch screen is unlocked with one hand in the prior art can be solved.

### CROSS REFERENCE TO RELATED DISCLOSURES

The present disclosure is a continuation of International Application No. PCT/CN2016/096424, filed on 23 Aug. 2016 which is based upon and claims the priority of Chinese patent disclosure No. 2016101801345, filed with Chinese Patent Office on Mar. 25, 2016, and entitled “CONTROL METHOD AND DEVICE FOR TERMINAL”, the entire contents of which are herein incorporated by reference.

### TECHNICAL FIELD

The present disclosure relates to the technical field of communication, and particularly relates to a control method and device for a terminal.

### BACKGROUND

Screens of current mainstream terminals are implemented as touch screens, and users operate the terminals by clicking or sliding functional keys on the touch screens.

When the terminal is not used, in order to prevent a certain function of a terminal from being triggered to start by carelessly touching the touch screen, the conventional terminal generally has a screen locking function. For example, when the terminal is not used, a power button can be manually clicked so that the terminal enters a screen locking state, or a screen locking time is set, and when the standby time of the terminal reaches the set screen locking time, the terminal enters a screen locking state. When the terminal is to be used again, the terminal needs to be unlocked in a manner of sliding or inputting an unlocking password or the like, so that the terminal enters a main interface.

In the process of implementing the present disclosure, the inventor discovers that the prior art at least has the following problems: as the touch screen of the terminal is increasingly large, it is inconvenient to unlock the terminal with one hand, so that the unlocking efficiency of the terminal is relatively low.

### SUMMARY

In view of this, the present disclosure provides a control method and device for a terminal for solving the problems in the prior art that it is inconvenient to unlock the terminal with one hand due to large touch screen of the terminal, so that the unlocking efficiency of the terminal is relatively low.

To achieve the above object, in one aspect, an embodiment of the present disclosure provides a control method for a terminal, including: acquiring operation information of a user at an edge touch area of the terminal in a screen locking state; and controlling the terminal to execute unlocking operation according to the operation information of the user at the edge touch area of the terminal.

In a further aspect, an embodiment of the present disclosure provides a terminal, including at least one processor and a memory in communication connection with the at least one processor, wherein the memory stores an instruction executable by the at least one processor, and the instruction is executed by the at least one processor, to enable the at least one processor to: acquire operation information of a user at an edge touch area of the terminal in a screen locking state; and control the terminal to execute unlocking operation according to the operation information of the user at the edge touch area of the terminal.

In a further aspect, an embodiment of the present disclosure provides a non-transient computer readable storage medium, which stores a computer executable instruction used for: acquiring operation information of a user at an edge touch area of a terminal in a screen locking state; and controlling the terminal to execute unlocking operation according to the operation information of the user at the edge touch area of the terminal.

In a further aspect, an embodiment of the present disclosure provides a computer program product, the computer program product includes a computer program stored on a non-transient computer readable storage medium, the computer program includes a program instruction which, when executed by a computer, causes the computer to execute the above methods.

### BRIEF DESCRIPTION OF DRAWINGS

One or more embodiments are illustrated via pictures in corresponding drawings, these illustrations do not limit the embodiments, components with the same reference numerical signs in the drawings are similar ones, and the pictures in the drawings do not have proportional limitations unless otherwise specified.

FIG. 1 is a flow diagram of embodiment 1 of a control method for a terminal provided by an embodiment of the present disclosure;

FIG. 2 is an exemplary diagram of an edge touch area of the terminal provided by an embodiment of the present disclosure;

FIG. 3 is a flow diagram of embodiment 2 of a control method for a terminal provided by an embodiment of the present disclosure;

FIG. 4 is a flow diagram of embodiment 3 of a control method for a terminal provided by an embodiment of the present disclosure;

FIG. 5 is a structural schematic diagram of a control device for a terminal provided by an embodiment of the present disclosure;

FIG. 6 is a schematic diagram of a hardware structure of a terminal for executing the control method for the terminal provided by an embodiment of the present disclosure.

### DETAILED DESCRIPTION

Preferred embodiments of the present disclosure will be illustrated below in combination with the accompanying drawings. It should be understood that the preferred embodiments described herein are merely used for illustrating and interpreting the present disclosure, rather than limiting the present disclosure.

It should be clear that the described embodiments are merely part of, not all of the embodiments of the present disclosure. Based on the embodiments in the present disclosure, all other embodiments obtained by those of ordinary skill in the art without any creative effort shall fall into the protection scope of the present disclosure.

The terms used in the embodiments of the present disclosure are for describing specific embodiments only, rather than limiting the present disclosure. Singular words “one”, “said” and “the” used in the embodiments and the appended claims of the present disclosure also intend to include most forms, unless the context clearly expresses other meanings.

It should be understood that the term “and/or” used in the present disclosure is merely an association relation for describing associated objects, and can express three relations, for example, A and/or B can express: single A, both A and B, and single B. In addition, the symbol “/” in the present disclosure generally expresses an “or” relation between front and back associated objects.

Upon the context, the word “if” used herein can be interpreted as “at the time of . . . ” or “when . . . ” or “responding to determination” or “responding to detection”. Similarly, upon the context, the phrase “if determining” or “if detecting (the stated condition or event)” can be interpreted as “when determining” or “responding to determination” or “when detecting (the stated condition or event)” or “responding to detection (the stated condition or event)”.

### Embodiment 1

FIG. 1 is a flow diagram of embodiment 1 of a control method for a terminal according to an embodiment of the present disclosure. As shown in FIG. 1, the control method for a terminal provided by this embodiment may include the following steps.

At 100, operation information of a user at an edge touch area of the terminal in a screen locking state is required.

For example, the terminal described in the embodiment of the present disclosure may include but not limited to a personal computer (PC), a personal digital assistant (PDA), a wireless handheld device, a tablet computer, a mobile phone, an MP3 player, an MP4 player, etc.

In the embodiment of the present disclosure, the operation information of the user at the edge touch area of the terminal may include but not limited to: operation information generated after sliding operation of the user at the edge touch area of the terminal, e.g., sliding gesture; or operation information generated after clicking operation of the user at the edge touch area of the terminal, e.g., number of clicks; or operation information generated after pressing operation of the user at the edge touch area of the terminal, e.g., pressure value; or input fingerprint of the user at the edge touch area of the terminal.

It could be understood that edge touch is input via the edge or the border of the terminal to track clicking, sliding or pressing of a finger on the edge of the terminal so as to control the mobile phone.

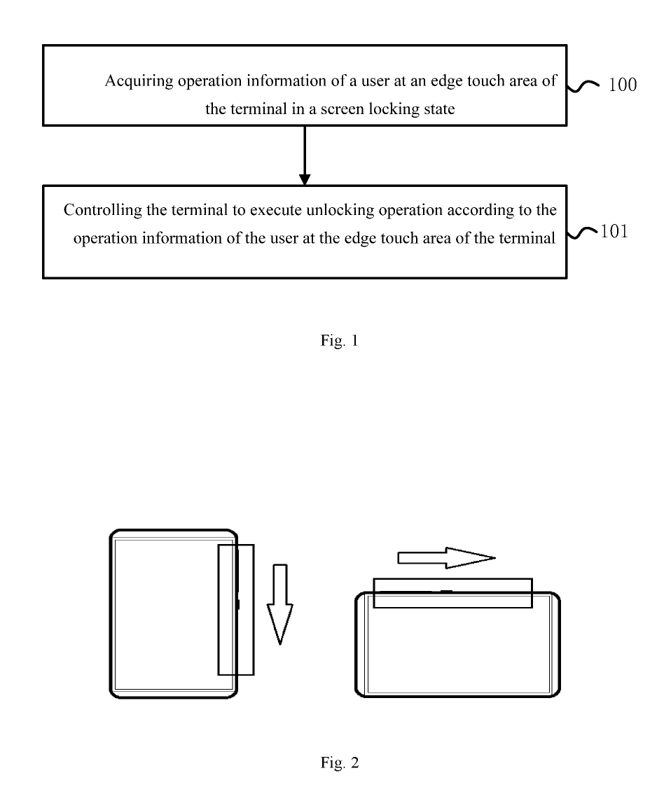

Please refer to FIG. 2, which is an exemplary diagram of an edge touch area of the terminal provided by an embodiment of the present disclosure. As shown in FIG. 2, the edge touch area of the terminal may be an area that the thumb of the user can reach on the sides of the terminal when the user naturally holds the terminal, and the sides of the terminal include other four sides except the front and the back.

In the embodiment of the present disclosure, the edge touch area of the terminal may be realized by a physical key, a virtual key, a sensor or a screen.

For example, if the terminal uses a curved screen, the edge touch area of the terminal can be realized by the edge screen of the curved screen. Using a capacitive touch screen as an example for illustration, when the finger of the user touches the edge touch screen, the capacitance of the contact is changed, so that the oscillator frequency related with the capacitance is changed, the touch position can be determined by measuring the change of the oscillator frequency, and then the operation information of the user at the edge touch area of the terminal can be acquired.

Or, for another example, the edge touch area of the terminal without using a curved screen can be realized by a physical key, a virtual key or a sensor.

For example, if a physical key for adjusting the volume is at the edge of the terminal, using the physical key for adjusting the volume in the terminal as an example for illustration, when the finger of the user presses the physical key for adjusting the volume, the terminal may learn that the user presses the key for improving the volume or the key for lowering the volume, and similarly, if the touch of the user at the edge tends to pressing operation, the operation information of the user at the edge touch area of the terminal can be acquired.

For another example, if virtual keys with certain functions are at the edge of the terminal and when the virtual keys are capacitive virtual keys, the terminal judges which virtual key the user touches via the capacitance of the capacitive virtual keys. Specifically, the finger and the electrode plate in the capacitive virtual key may form a capacitor when the user touches a capacitive virtual key, the terminal determines the touch position of the user by detecting the change of the capacitance so as to determine which virtual key the user touches, and then the operation information of the user at the edge touch area of the terminal can be acquired.

For a further example, if sensors with certain functions are at the edge of the terminal, using the sensors which are pressure sensors on the terminal as an example, when the user presses a pressure sensor, semiconductor deformation pressure is formed on the flaky surface of the pressure sensor, the flaky surface is deformed by pressing to produce a piezoelectric impedance effect, the change of the impedance is converted into an electrical signal, the terminal can determine which pressure sensor the user presses or which position on the pressure sensor the user presses after acquiring the electrical signal so as to determine which function of the pressure sensor the user presses, and then the operation information of the user at the edge touch area of the terminal can be acquired. In addition, the sensors with certain functions at the edge of the terminal may also be photo sensors.

Specifically, acquiring operation information of a user at an edge touch area of the terminal means acquiring operation information of the user on a valid area of the edge touch area of the terminal, and only the operation in the valid area can generate the corresponding operation information.

For example, if the terminal uses a curved screen, when the operation information of the user is acquired using the edge screen of the curved screen at the edge touch area of the terminal, the valid area of the edge screen is a screen edge area that the thumb of the user can click or touch when the user naturally holds the terminal.

101, controlling the terminal to execute unlocking operation according to the operation information of the user at the edge touch area of the terminal.

Specifically, different operation information is generated when the user carries out different operation on the terminal, and then corresponding functional modules of the terminal are triggered to fulfill the purpose to be achieved by the operation information. Thus, the purpose to be achieved by the operation information of the user at the edge touch area of the terminal can be preset in the terminal.

For example, the terminal generally enters a screen locking state after the terminal is not used. When the terminal is to be used again, the terminal needs to be unlocked in a manner of sliding or inputting an unlocking password or the like, so that the terminal enters a main interface. As the touch screen of the terminal is increasingly large, it is inconvenient to unlock the terminal with one hand, so that the unlocking efficiency of the terminal is relatively low.

When the user naturally holds the terminal, the finger easily touches the edge touch area of the terminal, so the purpose to be achieved by the operation information of the user at the edge touch area of the terminal can be set to control the terminal to unlock. In this case, after the operation information of the user at the edge touch area of the terminal is acquired, the operation information may trigger the terminal to unlock.

It should be noted that the execution main body of the control method for the terminal provided by the embodiment of the present disclosure may be a control device for the terminal, the device may be located at an disclosure of the local terminal or at a functional unit such as a plug-in or software development kit (SDK) and the like in the disclosure of the local terminal, and the embodiment of the present disclosure is not specially limited thereto.

It could be understood that the disclosure may be an disclosure program (nativeApp) installed on the terminal or a web program (webApp) of a browser on the terminal, and the embodiment of the present disclosure is not specially limited thereto.

In the control method for the terminal provided by the embodiment of the present disclosure, operation information of a user at an edge touch area of the terminal is acquired, and the terminal is controlled to execute unlocking operation according to the acquired operation information of the user at the edge touch area of the terminal. In the present disclosure, the terminal can be conveniently and quickly controlled to unlock by operation at the edge touch area of the terminal. Thus, with the technical solution of the present disclosure, when the terminal is controlled to unlock, the operation is simple and convenient, the unlocking efficiency of the terminal is improved, and the problem that the unlocking efficiency of the terminal is relatively low due to inconvenient operation when the terminal with a large touch screen is unlocked with one hand in the prior art can be solved.

### Embodiment 2

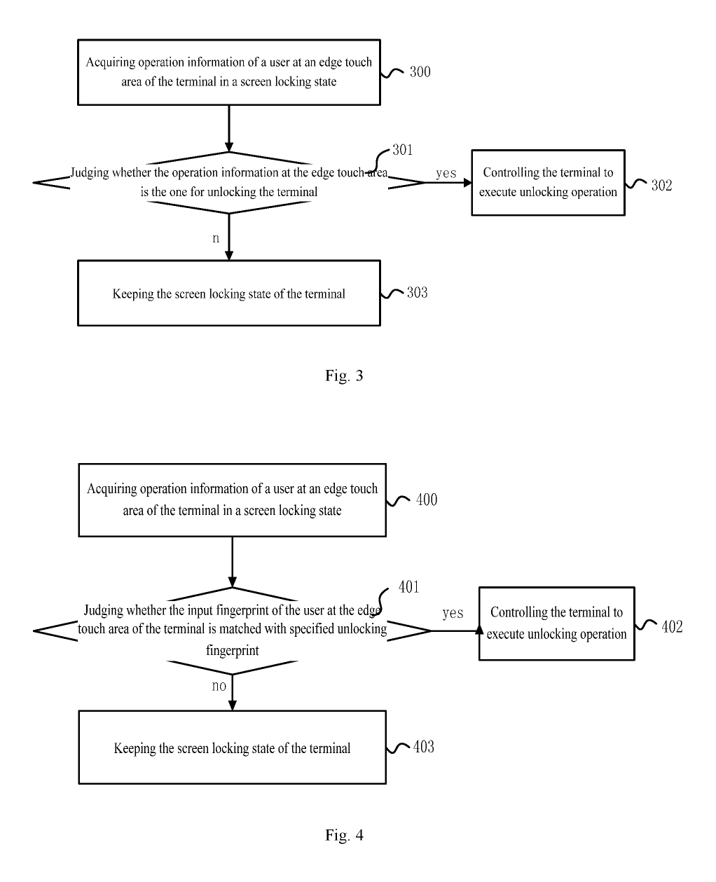

FIG. 3 is a flow diagram of embodiment 2 of a control method for a terminal provided by an embodiment of the present disclosure. As shown in FIG. 3, the control method for the terminal provided by the embodiment of the present disclosure further describes the technical solution of the embodiment of the present disclosure based on the embodiment shown in FIG. 1.

As shown in FIG. 3, the control method for the terminal provided by the embodiment of the present disclosure may specifically include the following steps.

300, acquiring operation information of a user at an edge touch area of the terminal in a screen locking state.

In the control method for the terminal provided by the embodiment of the present disclosure, the technical solution of the embodiment of the present disclosure is described, using the acquired operation information which is a sliding gesture as example.

301, judging whether the operation information at the edge touch area is operation information for unlocking the terminal; if the operation information at the edge touch area is operation information for unlocking the terminal, executing step 302; otherwise, if the operation information at the edge touch area is not operation information for unlocking the terminal, executing step 303.

Operation information for unlocking the terminal is preset in the terminal. After the operation information of the user at the edge touch area of the terminal is acquired, the operation information is matched with preset operation information for lightening the screen of the terminal, then whether the operation information is the preset operation information for unlocking the terminal is judged, step 302 is executed if the acquired operation information is the preset operation information for unlocking the terminal, otherwise, step 303 is executed if the acquired operation information is not the preset operation information for unlocking the terminal.

302, controlling the terminal to execute unlocking operation.

For example, the operation information for unlocking the terminal is a preset sliding gesture, at the moment, if the acquired operation information of the user at the edge touch area of the terminal is sliding at the edge touch area of the terminal, the sliding gesture generated by sliding at the edge touch area of the terminal is matched with the preset sliding gesture, and if the sliding gesture generated by sliding at the edge touch area of the terminal is consistent with the preset sliding gesture, the terminal is controlled to execute unlocking operation.

303, keeping the screen locking state of the terminal.

If the sliding gesture generated by sliding at the edge touch area of the terminal is not consistent with the preset sliding gesture, the screen locking state of the terminal is kept.

It should be noted that this embodiment is illustrated only using the acquired operation information which is a sliding gesture as an example, but is not limited to this implementation, for example, the acquired operation information may also be a pressure value or a number of clicks, its implementation principle is the same as the implementation principle of this embodiment, and reference may be made to the above relevant description, which is not redundantly described herein.

In the control method for the terminal provided by the embodiment of the present disclosure, operation information of a user at an edge touch area of the terminal is acquired, and the terminal is controlled to execute unlocking operation according to the acquired operation information of the user at the edge touch area of the terminal. In the present disclosure, the terminal can be conveniently and quickly controlled to unlock by operation at the edge touch area of the terminal. Thus, with the technical solution of the present disclosure, when the terminal is controlled to unlock, the operation is simple and convenient, the unlocking efficiency of the terminal is improved, and the problem that the unlocking efficiency of the terminal is relatively low due to inconvenient operation when the terminal with a large touch screen is unlocked with one hand in the prior art can be solved.

### Embodiment 3

FIG. 4 is a flow diagram of embodiment 3 of a control method for a terminal provided by an embodiment of the present disclosure. As shown in FIG. 4, the control method for the terminal provided by the embodiment of the present disclosure further describes the technical solution of the embodiment of the present disclosure based on the embodiment shown in FIG. 1.

As shown in FIG. 4, the control method for the terminal provided by the embodiment of the present disclosure may specifically include the following steps.

400, acquiring operation information of a user at an edge touch area of the terminal in a screen locking state.

For example, in order to improve the security of the terminal, the terminal is generally provided with a fingerprint identification area, and only the owner of the terminal can unlock the terminal, so input fingerprint of the user at the fingerprint identification area of the terminal needs to be acquired.

Generally, the fingerprint identification area can be set on a physical key on the front side of the terminal or on a physical key on the back of the terminal. As the screen of the terminal is increasingly large, one-hand operation is inconvenient, so the fingerprint identification area can be set at the edge touch area of the terminal, that is, the edge touch area of the terminal is a fingerprint identification area, and then the operation information of the user at the edge touch area of the terminal is input fingerprint of the user at the edge touch area of the terminal.

401, judging whether the input fingerprint of the user at the edge touch area of the terminal is matched with specified unlocking fingerprint; if the input fingerprint of the user at the edge touch area of the terminal is matched with specified unlocking fingerprint, executing step 402; otherwise, if the input fingerprint of the user at the edge touch area of the terminal is not matched with specified unlocking fingerprint, executing step 403.

402, controlling the terminal to execute unlocking operation.

403, keeping the screen locking state of the terminal.

This embodiment differs from embodiment 2 in that the operation information of the user at the edge touch area of the terminal is different, but its specific principle is the same as that of the first method, and reference may be made to the above relevant description, which is not redundantly described herein.

In the control method for the terminal provided by the embodiment of the present disclosure, operation information of a user at an edge touch area of the terminal is acquired, and the terminal is controlled to execute unlocking operation according to the acquired operation information of the user at the edge touch area of the terminal. In the present disclosure, the terminal can be conveniently and quickly controlled to unlock by operation at the edge touch area of the terminal. Thus, with the technical solution of the present disclosure, when the terminal is controlled to unlock, the operation is simple and convenient, the unlocking efficiency of the terminal is improved, and the problem that the unlocking efficiency of the terminal is relatively low due to inconvenient operation when the terminal with a large touch screen is unlocked with one hand in the prior art can be solved.

### Embodiment 4

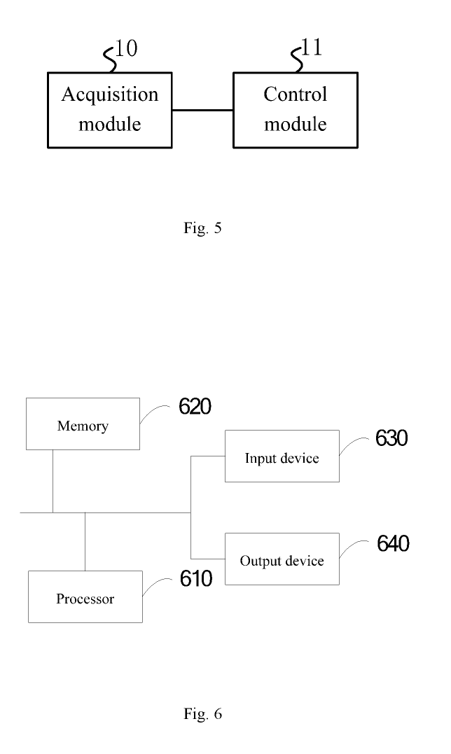

FIG. 5 is a structural schematic diagram of a control device for a terminal provided by an embodiment of the present disclosure. As shown in FIG. 5, the control device for the terminal provided by the embodiment of the present disclosure includes an acquisition module 10 and a control module 11.

In a specific implementation process, the modules can transmit information data and the like therebetween.

The acquisition module 10 is used for acquiring operation information of a user at an edge touch area of the terminal in a screen locking state.

The control module 11 is used for controlling the terminal to execute unlocking operation according to the operation information of the user at the edge touch area of the terminal.

For example, the operation information of the user at the edge touch area of the terminal includes: operation information generated after sliding operation of the user at the edge touch area of the terminal, e.g., sliding gesture; or operation information generated after clicking operation of the user at the edge touch area of the terminal, e.g., number of clicks; or operation information generated after pressing operation of the user at the edge touch area of the terminal, e.g., pressure value; or input fingerprint of the user at the edge touch area of the terminal.

In the control device for the terminal provided by the embodiment of the present disclosure, the implementation mechanism of controlling the terminal to execute unlocking operation by adopting the above modules is the same as that of the embodiment shown in FIG. 1 above, and reference may be made to the description of the embodiment shown in FIG. 1, which is not redundantly described herein.

According to the control device for the terminal provided by the embodiment of the present disclosure, an acquisition module 10 in the terminal acquires operation information of a user at an edge touch area of the terminal, and a control module 11 controls the terminal to execute unlocking operation according to the acquired operation information of the user at the edge touch area of the terminal. In the present disclosure, the terminal can be conveniently and quickly controlled to unlock by operation at the edge touch area of the terminal. Thus, with the technical solution of the present disclosure, when the terminal is controlled to unlock, the operation is simple and convenient, the unlocking efficiency of the terminal is improved, and the problem that the unlocking efficiency of the terminal is relatively low due to inconvenient operation when the terminal with a large touch screen is unlocked with one hand in the prior art can be solved.

Further, in a specific implementation process, the control module 11 in the control device for the terminal of the above embodiment is specifically used for: judging whether the operation information at the edge touch area is operation information for unlocking the terminal; and if the operation information at the edge touch area is operation information for unlocking the terminal, controlling the terminal to execute unlocking operation.

Further, the control module 11 is further used for: if the operation information at the edge touch area is not operation information for unlocking the terminal, keeping the screen locking state of the terminal.

In the control device for the terminal provided by the embodiment of the present disclosure, the implementation mechanism of controlling the terminal to execute unlocking operation by adopting the above modules is the same as that of the embodiment shown in FIG. 3 above, and reference may be made to the description of the embodiment shown in FIG. 3, which is not redundantly described herein.

Further, in a specific implementation process, in the control device for the terminal of the above embodiment, if the edge touch area is a fingerprint identification area, the operation information of the user at the edge touch area of the terminal is input fingerprint of the user at the edge touch area of the terminal.

The control module 11 is specifically used for: judging whether the input fingerprint of the user at the edge touch area of the terminal is matched with specified unlocking fingerprint.

If the input fingerprint of the user at the edge touch area of the terminal is matched with specified unlocking fingerprint, the terminal is controlled to execute unlocking operation.

In the control device for the terminal provided by the embodiment of the present disclosure, the implementation mechanism of controlling the terminal to execute unlocking operation by adopting the above modules is the same as that of the embodiment shown in FIG. 4 above, and reference may be made to the description of the embodiment shown in FIG. 4, which is not redundantly described herein.

According to the control device for the terminal provided by the embodiment of the present disclosure, an acquisition module 10 in the terminal acquires operation information of a user at an edge touch area of the terminal, and a control module 11 controls the terminal to execute unlocking operation according to the acquired operation information of the user at the edge touch area of the terminal. In the present disclosure, the terminal can be conveniently and quickly controlled to unlock by operation at the edge touch area of the terminal. Thus, with the technical solution of the present disclosure, when the terminal is controlled to unlock, the operation is simple and convenient, the unlocking efficiency of the terminal is improved, and the problem that the unlocking efficiency of the terminal is relatively low due to inconvenient operation when the terminal with a large touch screen is unlocked with one hand in the prior art can be solved.

### Embodiment 5

The embodiment of the present disclosure provides a non-volatile computer storage medium, the computer storage medium stores a computer executable instruction, and the computer executable instruction can execute the processing method in any above method embodiment.

### Embodiment 6

FIG. 6 is a schematic diagram of a hardware structure of a terminal for executing the control method for the terminal provided by an embodiment of the present disclosure. As shown in FIG. 6, the terminal includes one or more processors 610 and a memory 620. One processor 610 is used as an example in FIG. 6. The terminal may further include an input device 630 and an output device 640.

The processor 610, the memory 620, the input device 630 and the output device 640 can be connected via a bus or in other mode, using bus connection as an example in FIG. 6.

The memory 620 serving as a non-volatile computer readable storage medium can be used for storing non-volatile software programs, non-volatile computer executable programs and modules. The processor 610 runs the non-volatile software programs, instructions and programs stored in the memory 620 to execute various functional disclosures and data processing of the terminal, i.e., to implement the processing method in the above method embodiments.

The memory 620 may include a program storage area and a data storage area, wherein the program storage area can store an operating system and an disclosure program required by at least one function; and the data storage area can store data and the like. Moreover, the memory 620 may include a high-speed random access memory, and may also include a non-volatile memory, e.g., at least one disk storage device, a flash device or other non-volatile solid-state storage device. In some embodiments, the memory 620 may include memories arranged remotely relative to the processor 610, and these remote memories can be connected to the processor via a network. The example of the network includes but not limited to the internet, an intranet, a local area network, a mobile communication network and a combination thereof.

The input device 630 can receive input digit or character information and generate signal input. The output device 640 may include display equipment such as a display screen.

The one or more modules are stored in the memory 620, and are executed by the one or more processors 610 to execute: acquiring operation information of a user at an edge touch area of the terminal in a screen locking state; and controlling the terminal to execute unlocking operation according to the operation information of the user at the edge touch area of the terminal.

In a possible implementation, controlling the terminal to execute unlocking operation according to the operation information of the user at the edge touch area of the terminal includes: judging whether the operation information at the edge touch area is operation information for unlocking the terminal; and if the operation information at the edge touch area is operation information for unlocking the terminal, controlling the terminal to execute unlocking operation.

In a possible implementation, the method further includes: if the operation information at the edge touch area is not operation information for unlocking the terminal, keeping the screen locking state of the terminal.

In a possible implementation, the operation information of the user at the edge touch area of the terminal includes: operation information generated after sliding operation of the user at the edge touch area of the terminal; or operation information generated after clicking operation of the user at the edge touch area of the terminal; or operation information generated after pressing operation of the user at the edge touch area of the terminal.

In a possible implementation, the edge touch area is a fingerprint identification area, and the operation information of the user at the edge touch area of the terminal is input fingerprint of the user at the edge touch area of the terminal; judging whether the operation information at the edge touch area is operation information for unlocking the terminal includes: judging whether the input fingerprint of the user at the edge touch area of the terminal is matched with specified unlocking fingerprint; if the operation information at the edge touch area is operation information for unlocking the terminal, controlling the terminal to execute unlocking operation includes: if the input fingerprint of the user at the edge touch area of the terminal is matched with specified unlocking fingerprint, controlling the terminal to execute unlocking operation.

The above product can execute the methods provided by the embodiments of the present disclosure, and has corresponding functional modules for executing the methods and corresponding advantages. For the technical details not described in detail in this embodiment, reference may be made to the methods provided by the embodiments of the present disclosure.

The terminal in the embodiments of the present disclosure exists in multiple forms, including but not limited to:

Mobile communication equipment: the equipment has a mobile communication function, and has the main goals of providing speech and data communication. The terminal includes: a smart phone (e.g., iPhone), a multimedia phone, a functional phone, a low-end phone, etc.

Ultra-mobile personal computer equipment: the equipment belongs to the scope of personal computers, has computing and processing functions, and generally also has mobile internet characteristic. The terminal includes PAD, MID (Mobile Internet Device) and UMPC (Ultra Mobile Personal Computer) equipment and the like, e.g., iPad.

Portable entertainment equipment: the equipment can display and play multimedia contents. The equipment includes audio and video players (e.g., iPod), handheld game players, electronic book readers, intelligent toys and portable vehicle-mounted navigation equipment.

Server: equipment for providing computing services, including a processor, a hard disk, a memory, a system bus, etc., wherein the architecture of the server is similar to that of a general computer, but the server is highly required on the aspects of processing capability, stability, reliability, security, expandability, manageability and the like because it needs to provide high reliable services.

Other electronic devices with data interaction functions.

The above-described device embodiments are only schematic, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be achieved by selecting part of or all of the units according to actual needs.

Upon the descriptions of the above embodiments, those skilled in the art can clearly learn that each embodiment can be realized by means of software and a general hardware platform, and of course, can be realized via hardware. Based on such an understanding, the above technical solutions substantially or the parts making contribution to relevant technologies may be embodied in the form of a software product, and the computer software product can be stored in a storage medium, such as an ROM/RAM, a magnetic disk, an optical disk, etc., which includes a plurality of instructions enabling computer equipment (which may be a personal computer, a server, or network equipment and the like) to execute each embodiment or the method in some part of each embodiment.

Finally, it should be noted that the above embodiments are merely used for illustrating the technical solutions of the present disclosure, rather than limiting the present disclosure; though the present disclosure is illustrated in detail with reference to the aforementioned embodiments, it should be understood by those of ordinary skill in the art that modifications may still be made on the technical solutions disclosed in the aforementioned respective embodiments, or equivalent substitutions may be made to a part of technical characteristics thereof; and these modifications or substitutions do not make the nature of the corresponding technical solutions depart from the spirit and scope of the technical solutions of the respective embodiments of the present disclosure.

### INDUSTRIAL APPLICABILITY

According to the control method and device for the terminal provided by the embodiments of the present disclosure, operation information of a user at an edge touch area of the terminal in a screen locking state is acquired, and the terminal is controlled to execute unlocking operation according to the operation information of the user at the edge touch area of the terminal, so that when the terminal is controlled to unlock, the operation is simple and convenient, and the unlocking efficiency of the terminal is improved.

1. A control method for a terminal, comprising:
acquiring operation information of a user at an edge touch area of the terminal in a screen locking state; and
controlling the terminal to execute unlocking operation according to the operation information of the user at the edge touch area of the terminal.

2. The method of claim 1, wherein controlling the terminal to execute unlocking operation according to the operation information of the user at the edge touch area of the terminal comprises:
judging whether the operation information at the edge touch area is operation information for unlocking the terminal; and
if the operation information at the edge touch area is operation information for unlocking the terminal, controlling the terminal to execute unlocking operation.

3. The method of claim 2, further comprising:
if the operation information at the edge touch area is not operation information for unlocking the terminal, keeping the screen locking state of the terminal.

4. The method of claim 3, wherein the operation information of the user at the edge touch area of the terminal comprises:
operation information generated after sliding operation of the user at the edge touch area of the terminal; or
operation information generated after clicking operation of the user at the edge touch area of the terminal; or
operation information generated after pressing operation of the user at the edge touch area of the terminal.

5. The method of claim 3, wherein
the edge touch area is a fingerprint identification area, and the operation information of the user at the edge touch area of the terminal is input fingerprint of the user at the edge touch area of the terminal;
wherein, judging whether the operation information at the edge touch area is operation information for unlocking the terminal comprises: judging whether the input fingerprint of the user at the edge touch area of the terminal is matched with specified unlocking fingerprint; and wherein
if the operation information at the edge touch area is operation information for unlocking the terminal, controlling the terminal to execute unlocking operation comprises: if the input fingerprint of the user at the edge touch area of the terminal is matched with specified unlocking fingerprint, controlling the terminal to execute unlocking operation.

6. A terminal, comprising:
at least one processor; and
a memory in communication connection with the at least one processor; wherein
the memory stores an instruction executable by the at least one processor, and the instruction is executed by the at least one processor, to enable the at least one processor to: acquire operation information of a user at an edge touch area of the terminal in a screen locking state; and
control the terminal to execute unlocking operation according to the operation information of the user at the edge touch area of the terminal.

7. The terminal of claim 6, wherein controlling the terminal to execute unlocking operation according to the operation information of the user at the edge touch area of the terminal comprises:
judging whether the operation information at the edge touch area is operation information for unlocking the terminal; and
if the operation information at the edge touch area is operation information for unlocking the terminal, controlling the terminal to execute unlocking operation.

8. The terminal of claim 7, wherein the instruction is executed by the at least one processor, to enable the at least one processor to:
if the operation information at the edge touch area is not operation information for unlocking the terminal, keep the screen locking state of the terminal.

9. The terminal of claim 8, wherein the operation information of the user at the edge touch area of the terminal comprises:
operation information generated after sliding operation of the user at the edge touch area of the terminal; or
operation information generated after clicking operation of the user at the edge touch area of the terminal; or
operation information generated after pressing operation of the user at the edge touch area of the terminal.

10. The terminal of claim 8, wherein the edge touch area is a fingerprint identification area, and the operation information of the user at the edge touch area of the terminal is input fingerprint of the user at the edge touch area of the terminal;
judging whether the operation information at the edge touch area is operation information for unlocking the terminal comprises: judging whether the input fingerprint of the user at the edge touch area of the terminal is matched with specified unlocking fingerprint; and
if the operation information at the edge touch area is operation information for unlocking the terminal, controlling the terminal to execute unlocking operation comprises: if the input fingerprint of the user at the edge touch area of the terminal is matched with specified unlocking fingerprint, controlling the terminal to execute unlocking operation.

11. A non-transient computer readable storage medium, wherein the non-transient computer readable storage medium stores a computer executable instruction, which is used for: acquiring operation information of a user at an edge touch area of a terminal in a screen locking state; and
controlling the terminal to execute unlocking operation according to the operation information of the user at the edge touch area of the terminal.

12. The non-transient computer readable storage medium of claim 11, wherein controlling the terminal to execute unlocking operation according to the operation information of the user at the edge touch area of the terminal comprises:
judging whether the operation information at the edge touch area is operation information for unlocking the terminal; and
if the operation information at the edge touch area is operation information for unlocking the terminal, controlling the terminal to execute unlocking operation.

13. The non-transient computer readable storage medium of claim 12, wherein the method further comprises:
if the operation information at the edge touch area is not operation information for unlocking the terminal, keeping the screen locking state of the terminal.

14. The non-transient computer readable storage medium of claim 13, wherein the operation information of the user at the edge touch area of the terminal comprises:
operation information generated after sliding operation of the user at the edge touch area of the terminal; or
operation information generated after clicking operation of the user at the edge touch area of the terminal; or
operation information generated after pressing operation of the user at the edge touch area of the terminal.

15. The non-transient computer readable storage medium of claim 13, wherein
the edge touch area is a fingerprint identification area, and the operation information of the user at the edge touch area of the terminal is input fingerprint of the user at the edge touch area of the terminal;
wherein, judging whether the operation information at the edge touch area is operation information for unlocking the terminal comprises: judging whether the input fingerprint of the user at the edge touch area of the terminal is matched with specified unlocking fingerprint; and wherein
if the operation information at the edge touch area is operation information for unlocking the terminal, controlling the terminal to execute unlocking operation comprises: if the input fingerprint of the user at the edge touch area of the terminal is matched with specified unlocking fingerprint, controlling the terminal to execute unlocking operation.
